(19) United States
(12) Patent Application Publication
(10) Pub. No.: US 2011/0212842 A1
(43) Pub. Date: Sep. 1, 2011

(54) METHOD FOR SCREENING LIGAND

(75) Inventors: Takahisa Ibii, Yokohama-shi (JP); Satoru Hatakeyama, Kawasaki-shi (JP)

(73) Assignee: CANON KABUSHIKI KAISHA, TOKYO (JP)

(21) Appl. No.: 13/023,056

(22) Filed: Feb. 8, 2011

(30) Foreign Application Priority Data
Feb. 26, 2010 (JP) 2010-043558

(51) Int. Cl. C40B 10/00

(52) U.S. Cl. 506/1

(57) ABSTRACT

The present invention provides a method for screening for a ligand having an affinity for a target substance and having readiness for conformational change forming a desired conformation upon binding to a target substance. The method includes the steps of (a) contacting a first mixture of candidate ligands with a carrier, followed by separating and collecting, as a second mixture of candidate ligands, a mixture of free candidate ligands not bound to the carrier, (b) contacting the second mixture of candidate ligands with the target substance, and (c) contacting the carrier with a solution containing the target substance and the mixture of candidate ligands obtained in step (b), and then separating and enriching a ligand, at least a part of which forms the particular conformation.

### BACKGROUND OF THE INVENTION

1. Field of the Invention

The present invention relates to methods for screening for a ligand, and in particular, to a method for screening for a ligand, at least a part of which forms a particular conformation upon binding to a target substance.

2. Description of the Related Art

A chemical sensor is a device including a molecular recognition element that selectively recognizes a target substance of a sensing subject and a signal transducer element that converts a chemical phenomenon (e.g., chemical potential, heat, an optical change) that occurs upon the recognition of the target substance into an electrical signal, etc. In particular, a chemical sensor utilizing a molecular recognition mechanism of a biological molecule is referred to as a biosensor. The biosensor may use a biological molecule (e.g., a nucleic acid, an amino acid, an antibody, a nucleic acid, a lipid, a sugar chain, an ion channel) as a molecular recognition element. Accordingly, the biosensor can retain high specificity for a target substance. Recently, a biological molecule has been employed as a tool for target substance recognition with high specificity. In addition, there has been an approach aiming at regulating a signal activity of a sensor by a specific conformational change in a biological molecule, which change occurs upon binding to a target substance. Utilizing the conformational change that occurs upon binding to the target substance should produce advantages, including shortening of detection time, no need for troublesome washing operations so as to remove non-specific molecules other than a target substance, and high sensitivity resulting from the phenomenon that binding to a molecule other than the target substance does not cause a change in the signal.

As an example of sensing that utilizes a conformational change, there have been numerous reports on sensing that uses an aptamer capable of causing a conformational change upon binding to a target substance. The aptamer is a ligand including a nucleic acid or a peptide which specifically binds to a target substance. In 1990, its basic principle has been first to be presented by Gold et al. There has been a report on a method for selecting and obtaining an aptamer from a nucleic acid molecule library by using what is called a SELEX (the Systematic Evolution of Ligands by EXponential enrichment) method utilizing the binding affinity for a target substance as an selective pressure. Until now, a wide variety of molecules have been disclosed as a target substance for an aptamer. Examples of the reported target substance include, for example, a variety of proteins, enzymes, peptides, antibodies, receptors, hormones, amino acids, antibiotics and other various compounds.

In addition, SELEX methods utilizing the binding affinity for a target substance as a selective pressure have often been modified so as to improve the affinity and specificity for a target substance for various applications such as chemical- or biosensors, molecular switches, diagnostic agents. U.S. Pat. No. 5,707,796 discloses that a nucleic acid aptamer having a particular conformational property (e.g., a nucleic acid aptamer including a bent DNA) is selected by using a combination of SELEX and gel electrophoresis so as to obtain an aptamer having a particular conformation. In addition, there has been a report on an in vitro selection method of a conformation-switching-signaling aptamer so as to aim at obtaining an aptamer for a sensor utilizing a conformational change upon binding to a target sequence.

Besides, as a sensor which utilizes an aptamer undergoing a conformational change upon binding to a target sequence, a method for using, for example, a fluorescent reporter is found to be particularly useful. In respect to the above method for using a fluorescent reporter, various related methods have been developed. Examples of the reported methods include, for example, a monochromophore approach, an aptamer beacon (bichromophore approach), an antitode (duplex-to-complex conformation-switching approach, QDNA), an in situ labeling approach, a chimeric aptamer approach and a fluorescent dyeing approach. In addition, a method for utilizing a conformational change of a protein (as a biological molecule other than an aptamer) upon binding to a target substance has been reported. For example, an electrochemical detection method is known which detects a conformational change of a protein upon recognition of a target substance as a difference in potential or current caused by a change in the interaction between a redox reporter molecule and the surface of an electrode.

The conformational change of a ligand upon binding to a target substance provides an important function affecting a SNR (signal-to-noise ratio) or limit of detection of a sensor. Strongly desired is development of a technic for precisely regulating a conformational change and a simple, systematic and robust technique for obtaining a ligand in which binding to a target substance causes a conformational change.

### SUMMARY OF THE INVENTION

The method disclosed in U.S. Pat. No. 5,707,796 enables an aptamer having a particular conformation to be obtained. However, the method fails to specify the kind of a conformation that a nucleic acid ligand is caused by the binding to a target substance, and thus cannot efficiently select a nuclear ligand having a desired conformation.

A method for in vitro selection of a conformation-switching-signaling aptamer which is obtained by utilizing the binding affinity to a target substance and the capability to induce its conformational change upon binding to the target substance as a selective pressure and a sensor used in a duplex-to-complex conformation-switching aptamer approach (bichromophore approach) are disclosed. This method beforehand engineers a plurality of regions as conserved sequence domains (including PBDs (Primer Binding Domains) and central-conserved sequence motifs) of a mixture of candidate nucleic acid. However, each conserved sequence domain does not provide a complementary sequence and does not have a function to form an intramolecular duplex within the conserved sequence domain.

Besides, this aptamer sensor is used in a duplex-to-complex conformation-switching approach (bichromophore approach). Two kinds of labeled-oligoDNAs (FDNA, QDNA) are complementary to the central-conserved sequence motif and one of the fixed PBDs, respectively, to form a duplex. Then, it is disclosed that the distance between the FDNA and the QDNA changes due to a conformational change resulting from the binding to a target substance or the distance changes due to the dissociation of the FDNA, so that the target substance is then detected. Although this method is a method for obtaining a labeled-aptamer molecule having the capability to induce its conformational change upon binding to a target substance while keeping an affinity for a target substance by using a common sequence, the method does not regulate a resulting conformational change (duplex formation) following the binding to the target substance. In addition, in some target substance the degree of the above conformational change does not remain constant, and it is predicted to be difficult to regulate the dissociation of the FDNA by the binding to a target substance. Consequently, the distance between the FDNA and the QDNA may not be precisely regulated.

In respect to a method for obtaining a nucleic acid ligand (a molecular beacon aptamer) used for a sensor that utilizes a conformational change in the nucleic acid ligand, a systematic approach has been adopted, the approach including obtaining a nucleic acid ligand sequence by a SELEX method and imparting the capability to induce its conformational change upon binding to a target substance to the ligand by modifying the ligand sequence. Nobuko Hamaguchi et al., Analytical Biochemistry 294, 126-131, 2001, have reported a molecular beacon aptamer having an ability of undergoing a conformational change (duplex formation) upon binding to a target substance. Since the reengineering of the sequence is need to impart the capability to induce the conformational change after obtaining the nucleic acid ligand by screening, such a method may lose the affinity for the target substance. Alternatively, there is a concern that the necessity of reengineering depending on the respective sequence is brought about. Furthermore, a current situation tells that the above method cannot be said to be a robust method because optimal engineering is required to be repeated for each nucleic acid ligand obtained.

In addition, there is a sensing method which regulates a conformational change by adding a sequence, as an antidote, complementary to a nucleic acid ligand sequence obtained by a SELEX method. However, the affinity for a target substance may change, and also the optimal engineering (e.g., a sequence, a length of the sequence, an insertion of mismatch, a position of the sequence) is required for an individual ligand. Accordingly, the method cannot be applied to a ligand other than the nucleic acid ligand.

Dattelbaum J. et al., Protein Science, 2005, vol. 14, 284-291, have reported a biosensor utilizing a conformational change of a protein upon binding to a ligand. In this method, a recombinant protein is produced which modifies a fluorescent molecule by altering a portion of amino acids of the maltose-binding protein (MBP). It is known that MBP changes a part of its conformation by binding to maltose. The engineered MBP enables the fluorescent intensity to be modified by a change in the local environment of the labeled fluorescent molecule, the change mediated by the conformational alteration upon binding to maltose. However, this method cannot be said to be a robust method because of the following concerns: a method is not yet established which imparts the binding affinity for a target substance other than sugars (e.g., maltose, glucose); the amino acid position which shall modify the fluorescent molecule must be optimized for the individual target substance; and the binding affinity for the target substance is not guaranteed after introduction of the fluorescent molecule.

That is, there exists no method for screening a mixture of candidate ligands for a ligand, based as a selective pressure on both the binding affinity for a target substance and the capability to induce a particular conformational change of the ligand upon binding to the target substance.

As a result of intensive studies to solve the problems with the above-mentioned conventional techniques, the present inventors have found out a method for screening for a ligand based as a selective pressure on both the binding affinity for a target substance and the capability to induce a particular conformational change upon binding to the target substance.

A method for screening for a nucleic acid ligand of the present invention is a method for screening for a ligand, at least a part of which forms a particular conformation upon binding to a target substance, the method including the steps of: (a) contacting a first mixture of candidate ligands containing a plurality of candidate ligands with a carrier having a recognizing site recognizing at least a part of the particular conformation, followed by separating and collecting, as a second mixture of candidate ligands, a mixture of free candidate ligands not bound to the carrier; (b) contacting the second mixture of candidate ligands with the target substance; and (c) contacting the carrier with a solution containing the target substance and the mixture of candidate ligands obtained in step (b), and then separating and enriching a ligand, at least a part of which has the particular conformation when binding to the target substance, from a mixture of candidate ligands obtained in step (b) by utilizing the ability of the recognizing site on the carrier to recognize at least the part of the particular conformation.

In addition, another method for screening for a nucleic acid ligand of the invention is a method for screening for a ligand, at least a part of which forms a particular conformation upon binding to a target substance, the method including the steps of: (a′) contacting a first mixture of candidate ligands containing a plurality of candidate ligands with the target substance; (b′) contacting a solution containing the target substance and the first mixture of candidate ligands obtained in step (a′) with a carrier having a recognizing site recognizing at least a part of the particular conformation, followed by collecting, as a second mixture of candidate ligands, a mixture of candidate ligands bound to the carrier by utilizing the ability of the recognizing site on the carrier to recognize at least the part of the particular conformation; (c′) removing the target substance from a solution containing the second mixture of candidate ligands; and (d′) contacting the carrier with the mixture of candidate ligands obtained in step (c′), and then separating and removing a candidate ligand, at least a part of which forms the particular conformation under the absence of the target substance, from a mixture of candidate ligands obtained in step (c′) by allowing the candidate ligand to be recognized by the recognizing site, and by utilizing the ability of the recognizing site on the carrier to recognize at least the part of the particular conformation.

A kit of the present invention is a kit for screening for a ligand, at least a part of which forms a particular conformation upon binding to a target substance. The kit includes a mixture of candidate ligands or mixture of candidate ligands precursor and a carrier having a recognizing site recognizing at least a part of the particular conformation.

The present invention can provide a novel method for screening, efficiently and systematically, for a ligand which has an affinity for a target substance, and at least a part of which forms a particular conformation upon binding to a target substance.

The resulting ligands according to a method of the present invention can contribute to applications in various fields (e.g., various chemical- or biosensors, molecular switches, diagnostic agents) by utilizing a conformational change of a ligand upon binding reaction with a target substance. In particular, a labeled ligand into which reporter molecules (e.g., fluorescent molecules) are intramolecularly introduced enables the distance, including a spacial arrangement, between two types of the reporter molecules after the binding to the respective target substance to be precisely regulated.

Further features of the present invention will become apparent from the following description of exemplary embodiments with reference to the attached drawings.

### BRIEF DESCRIPTION OF THE DRAWINGS

FIG. 1 is a diagram showing an example of a method for screening of an embodiment of the present invention.

FIG. 2 is a diagram showing an example of a method for screening of an embodiment of the present invention.

FIG. 3 is a diagram showing an example of a method for screening of an embodiment of the present invention.

FIG. 4 is a diagram showing an example of a method for screening of an embodiment of the present invention.

FIG. 5 is a diagram showing an example of a method for enriching a candidate ligand having an affinity for a target substance by utilizing a binding affinity for the target substance as an index.

### DESCRIPTION OF THE EMBODIMENTS

Preferred embodiments of the present invention will now be described in detail in accordance with the accompanying drawings.

Hereinafter, embodiments of the present invention are described using Figures and Examples. In addition, of note is that these Figures, Examples and descriptions are for the illustration of the present invention, and do not limit the scope of the present invention. It is needless to mention that additional embodiments which can be carried out in a manner adding various improvements, modifications and changes based on knowledge of those skilled in the art are within the scope of the present invention, as long as they are in agreement with the purport of the present invention.

### The First Embodiment

A method for screening for a ligand according to a first embodiment of the present invention is a method for screening for a nucleic acid ligand, at least a part of which forms a particular conformation upon binding to a target substance, from a mixture of a candidate nucleic acid ligand, the method including the following steps (a) to (c).

Specifically, the method includes the steps of:

(a) contacting a first mixture of candidate ligands containing a plurality of candidate ligands with a carrier having a recognizing site recognizing at least a part of the particular conformation, followed by separating and collecting, as a second mixture of candidate ligands, a mixture of free candidate ligands not bound to the carrier; (b) contacting the second mixture of candidate ligands with the target substance; and (c) contacting the carrier with a solution containing the target substance and the mixture of candidate ligands obtained in step (b), and then separating and concentrating a ligand, at least a part of which forms the particular conformation by binding to the target substance, from a mixture of candidate ligands obtained in step (b) by utilizing the ability of the recognizing site on the carrier to recognize at least the part of the particular conformation.

In addition, step (a) or step (c), or both step (a) and step (c) each can repeat any number of times that are required, and the number of times is not limited. As long as the adequate ratio of the number of the targeted candidate ligand population to the number of the untargeted candidate ligand population is retained to succeed the screening or the ratio is enough to identify the targeted ligand, the number of times is not limited.

According to the present invention, the method includes contacting a mixture of candidate ligands with a carrier having a recognizing site recognizing at least a part of a particular conformation, and thereafter screening for a ligand having a desired function based on a difference in an affinity between the candidate ligand and the recognizing site.

Besides, the phrase “under the presence of a target substance” described hereinafter means that target substance exists in a free-state or binding to the carrier. In contrast, the phrase “under the absence of a target substance” means that the target substance do not exist neither in a free-state nor binding to the carrier.

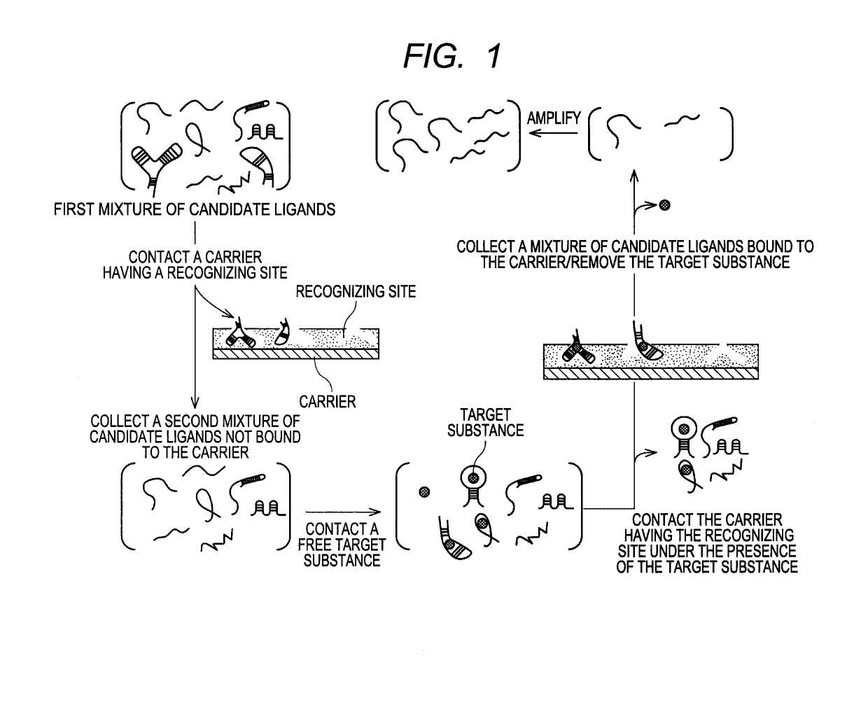

This embodiment allows a candidate ligand that readily forms at least a part of a particular conformation under the absence of a target substance (i.e., untargeted ligands) to be separated and removed from the candidate ligands by utilizing the readiness of the particular conformation for adsorption onto the carrier, following contacting the above carrier with the mixture of candidate ligands under the absence of a target substance. In addition, this embodiment can further include step (d) of removing the target substance from a solution containing the enriched ligand after step (c). FIG. 1 shows the example of a method for screening of the present invention.

First, a first mixture of candidate ligands is contacted with a carrier under the absence of a target substance. Then, a mixture of free candidate ligand not bound to the carrier is separated and collected as a second mixture of candidate ligands. This operation enables candidate ligands already having at least a part of a particular conformation under the absence of the target molecule to be removed. Subsequently, the target substance is made to contact the second mixture of candidate ligands collected. The second mixture of candidate ligands is expected to include a ligand capable of undergoing a conformational change upon binding to the target substance. The carrier is made to contact the second mixture of candidate ligands again while keeping the contact with the target substance. Then, the targeted ligand having at least a part of the particular conformation upon binding to the target substance can be separated and enriched.

Additionally, as a method for screening of the present invention, a plurality of different carriers, each of them having a different recognizing site, may be used. Alternatively, a single carrier having a plurality of different recognizing sites may be used.

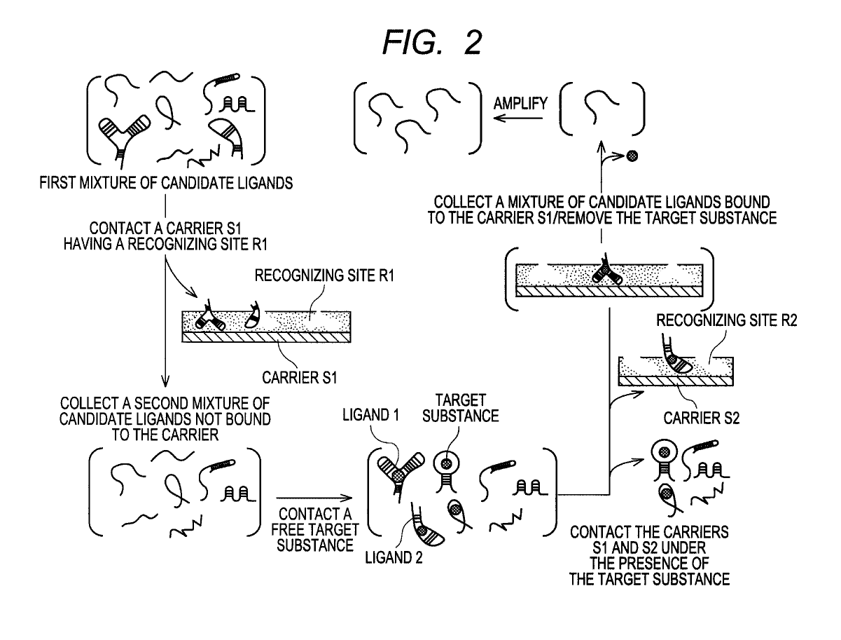

An example thereof is illustrated in FIG. 2. When a plurality of carriers, each of them having a different recognizing site, is used, a ligand having a conformation more similar to the desired conformation upon binding to the target substance should be obtained. As described in FIG. 2, there are used a carrier S1 having a recognizing site R1 and a carrier S2 having a recognizing site R2.

The recognizing site R2 recognizes a conformation similar to a part of the conformation that the recognizing site R1 recognizes. A first mixture of candidate ligands is made to contact the carrier S1 having the recognizing site R1 under the absence of a target substance. A ligand is removed, the ligand having a conformation, as an initial conformation, that is recognized by the recognizing site R1. Free ligands are collected as a second mixture of candidate ligands. After that, to the second mixture of candidate ligands is added a free target substance, thereby forming a complex with the target substance. Binding to the target substance results in a ligand 1 and a ligand 2, each of which forms a different conformation.

When there is a possibility that use of the carrier S1 enables both the ligand 1 and ligand 2 to be collected, a ligand forming the conformation shown in ligand 1 can be further enriched by using a plurality of recognizing sites as follows. First, the carrier S1 and the carrier S2 are made to contact the ligand. In terms of the order, the contacts with the carriers may be performed simultaneously or in separate occasions. The last carrier may be a carrier having a recognizing site with the highest affinity for the desired conformation. The ligand 2 can be removed by making the ligand 2 bind selectively to the recognizing site R2 of the carrier S2 by utilizing the steric hindrance due to a difference in the diameter of the ligand and by utilizing the ligand shape complementary to that of the recognizing site. In addition, ligands which do not bring about a conformational change or form a conformation largely different from the desired conformation are removed as free substances that do not bind to the carrier. Including the above operation in the screening enables the screening to be performed efficiently and in a manner having a higher concentration of the ligand forming a conformation more similar to the desired conformation.

### The Second Embodiment

A method for screening for a ligand according to a second embodiment of the present invention is a method for screening for a nucleic acid ligand, at least a part of which forms a particular conformation upon binding to a target substance, from a mixture of candidate nucleic acid ligand, the method including the following steps (a′) to (d′).

Specifically, the method includes the steps of: (a′) contacting a first mixture of candidate ligands containing a plurality of candidate ligands with the target substance; (b′) contacting a solution containing the target substance and the mixture of candidate ligands obtained in step (a′) with a carrier having a recognizing site recognizing at least a part of the particular conformation, followed by collecting, as a second mixture of candidate ligands, the mixture of candidate ligands bound to the recognizing site by utilizing the ability of the recognizing site on the carrier to recognize at least the part of the particular conformation; (c′) removing the target substance from a solution containing the second mixture of candidate ligands; and (d′) contacting the carrier with the mixture of candidate ligands obtained in step (c′), and then separating and removing a candidate ligand, at least a part of which has the particular conformation under the absence of the target substance, from a mixture of candidate ligands obtained in step (c′) by allowing the candidate ligand to be recognized by the recognizing site, and by utilizing the ability of the recognizing site on the carrier to recognize at least the part of the particular conformation.

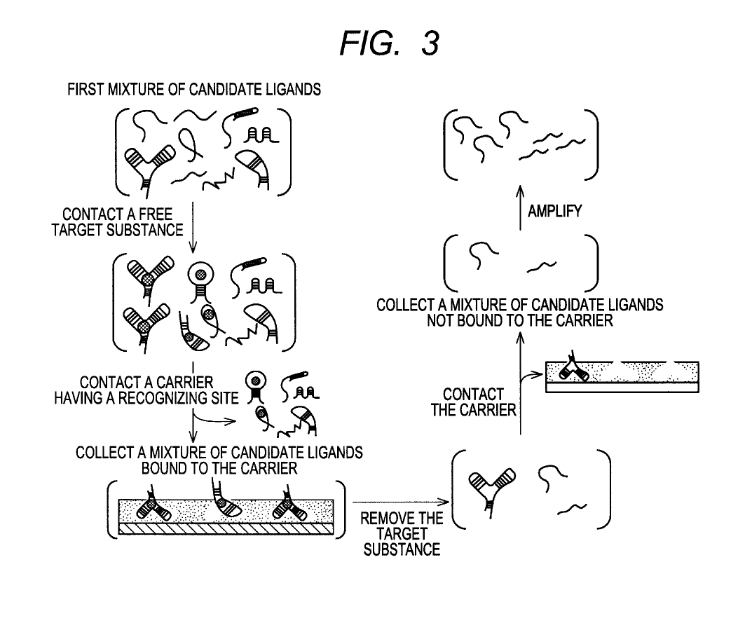

The difference of this embodiment from the first embodiment is that the first step is carried out under the presence of a target substance. Carrying out under the presence of the target substance enables a candidate ligand, as a targeted ligand, at least a part of which has a particular conformation by binding to the target substance to be separated and enriched. As long as the screening is possible, the adequate ratio of the number of the targeted candidate ligand population to the number of the untargeted candidate ligand population to succeed the screening is retained or the ratio is enough to identify the targeted ligand, the number of times for this separation operation may be any numbers. FIG. 3 illustrates the example of a method for screening of the present invention.

First, a first mixture of candidate ligands is made to contact a target substance. Next, they are made to contact a carrier having a recognizing site recognizing at least a part of a particular conformation. This operation allows candidate ligands having at least the part of the particular conformation recognized by (bound to) the recognizing site of the carrier to be separated and collected. The ligands separated and collected candidate by the above operation having at least the part of the particular conformation recognized by the recognizing site of the carrier include also a candidate ligand recognized by the carrier without binding to the target substance, in addition to a candidate ligand that have a particular conformation recognized by the carrier as a result of the binding of the targeted ligand to the target substance.

Here, utilizing the ability of the targeted ligand to form at least a part of the particular conformation only upon binding to the target substance, the targeted ligand is separated and collected by removing the target substance from the ligand which is binding to the target substance and which is separated and collected in the previous process, followed by contacting the ligand with the carrier again. The above operation makes a untargeted ligand, having at least a part of the particular conformation under the absence of the target substance, recognize (bind to) the recognizing site of the carrier. In contrast, the targeted ligand does not have at least the part of the particular conformation any more after the separation from the target substance. Accordingly, the targeted ligand can be collected because it is not recognized by the recognizing site of the carrier.

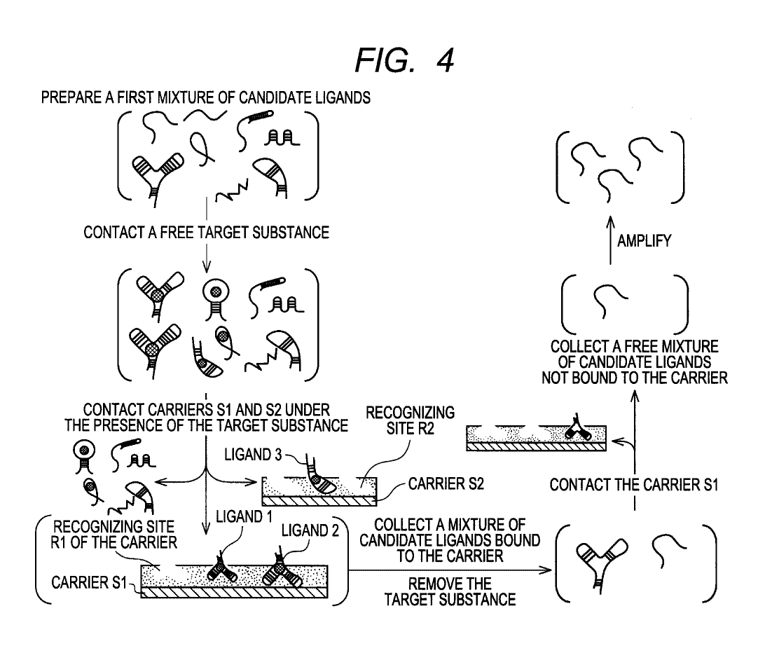

Additionally, in a manner similar to the first embodiment, a plurality of different carriers, each of which has a different recognizing site, may be used. Alternatively, a single carrier having a plurality of different recognizing sites may be used. FIG. 4 illustrates an example thereof.

The carrier S1 and the carrier S2 are used. A first mixture of candidate ligands is made to contact a target substance. Next, the carrier S1 and the carrier S2 are made to contact the ligand. In terms of the order, the contacts with the carriers may be performed simultaneously or in separate occasions. The last carrier may be a carrier having a recognizing site with the highest affinity for the desired conformation. A ligand that binds to the target substance but not form at least a part of a particular conformation is removed. Also removed is a ligand 3 bound to the carrier while the ligand forms a conformation largely different from the desired conformation. The ligand binding to the carrier S1 is collected. The target substance is removed, and the ligand is made to contact the carrier S1 again. The targeted ligand 1 forming at least the part of the particular conformation by binding to the target substance can be separated and enriched by utilizing a lower affinity of the ligand 1 for the carrier S1 under the absence of the target substance. Including the above operation in the screening enables the screening to be performed efficiently and in a manner having a higher concentration of the ligand capable of forming a conformation more similar to the desired conformation.

### The Third to Fifth Embodiments

A third embodiment of the present invention provides a screening which combines a conventional SELEX method. Specifically, before step (a) or (b), or step (a′), in order that a candidate ligand having a higher affinity for a target substance than the first and second mixture of candidate ligands forms a complex with the target substance, the embodiment further include the steps of: contacting the mixture of candidate ligands with the target substance; separating and collecting a candidate ligand that forms the complex; and producing a new mixture of candidate ligands by amplifying the candidate ligand separated and collected in the previous step. In addition, after step (d) or (d′), in order that a candidate ligand having a higher affinity for the target substance than the collected mixture of candidate ligands forms a complex with the target substance, the embodiment further include the steps of: contacting the mixture of candidate ligands with the target substance; separating and collecting a candidate ligand bound to the target substance; and producing a new mixture of candidate ligands by amplifying the candidate ligand separated and collected in the previous step.

A fourth embodiment of the present invention provides a method for identifying a sequence of a nucleic acid ligand, at least a part of which forms a particular conformation, the ligand obtained according to the above three embodiments of the method for screening. This embodiment is described specifically in the following Examples.

A fifth embodiment of the present invention provides a kit for screening for a nucleic acid ligand, at least a part of which forms a particular conformation upon binding to a target substance, from a mixture of candidate nucleic acid ligand so as to carry out the above respective embodiments. The kit includes a mixture of candidate ligands or mixture of candidate ligands precursor and a carrier having a recognizing site recognizing at least a part of the particular conformation.

The followings are descriptions of a ligand, etc., that is used in the present invention. Unless otherwise particularly mentioned, they are applied to all of the above embodiments.

(A Ligand and a Mixture of Candidate Ligands)

The term “ligand” herein refers to an artificial ligand having a desired effect in chemical- and biosensors, molecular switches, diagnostic agents and the like. Such a ligand generally includes what is called an “aptamer”, herein the term “aptamer” represents the same as the “ligand”. Examples of the desired effect include, but are not limited to, binding to a target substance, catalytically changing a target substance, inhibiting an effect of the target substance, promoting a reaction of the target substance with other molecules, and the like.

The “mixture of candidate ligands” herein means a mixture of candidate ligands molecules including one or more compounds, the mixture containing a desired ligand. A publicly known compound library, but is not limited to, can be used as such the mixture of candidate ligands. For example, DNA libraries, RNA libraries, mRNA libraries, cDNA libraries, genomic libraries, peptide libraries, antibody libraries or combinations thereof may be used. A component compound of these libraries may be chemically modified or engineered. A commercially available one may be used for these libraries, or they can be constructed based on a conventional publicly known technique.

The term “particular conformation” herein means a conformation of a ligand component where at least a part of which forms a predetermined spacial arrangement when binding to a target substance enables. Such particular conformation can be selected by referring to conformation databases (e.g., Protein Data Bank (PDB)) of biological molecules (e.g., nucleic acids, peptides, proteins). In addition, a conformation that is predicted in in silico conformation analysis by using commercially available software for conformation modeling can be used. A detailed ligand conformation under the presence or absence of a target substance can be determined with X-ray crystallography or nuclear magnetic resonance spectroscopy (NMR), etc.

The ligand and candidate ligand molecule according to the present invention may include a conserved sequence domain that includes a homologous region in addition to a random sequence domain that is different for each of individual molecules. As an example, the conserved sequence domains can be engineered to be inserted at both sides of the random sequence domain, so that the random sequence domain is sandwiched therebetween.

In respect to the candidate ligand molecule that is used in the screening, the conserved sequence domain may be deleted because, in the present invention, it is not always necessary to make the conserved sequence domain approach the target substance or the recognizing site of the carrier. When the candidate ligand molecule is, for example, DNA or RNA, a primer binding region for amplification by PCR or a complementary sequence thereof is added at the site of the conserved sequence domain deleted.

The conserved sequence domains may be inserted at both sides of the molecular region adjacent to a region having a high degree of the conformational change upon binding, to the extent without further changing the altered conformation, following to identifying one or more ligands obtained according to the present invention and analyzing the conformation of the ligands at the time of binding to a target substance. After that, a final ligand can be yielded.

The “ligand” or “candidate ligand” herein does not have a particular limitation, as long as having a given function (i.e., a conformational change upon binding to a target substance). In view of the variations of conformation that can be formed, the ligand (or the candidate ligand) may include nucleic acids, peptides, or derivatives thereof. If the ligand is a nucleic acid, examples of the ligand include, but are not limited to, single-stranded or double-stranded DNA, RNA and synthetic DNA, synthetic RNA, peptide nucleic acid, cross-linked nucleic acid (BNA, Bridged Nucleic Acid) and chemically modified derivatives thereof. Examples of the chemical modification include, but are not limited to, the 3′ and 5′ modifications such as capping. The examples further include, for example, phosphorylation, amination, biotinylation, thiolation, PEGylation and fluorescent labeling.

A modification suitable for a method for utilizing a ligand obtained by a method for screening of the present invention may be carried out both at the ends of the sequence and within the sequence. Examples of the modification include those providing an additional chemical group, with which modifications a whole ligand or portion thereof incorporates charge, polarizability, hydrogen bonding, electrostatic interactions and/or fluidity. These modifications enable variations of the affinity for a target substance and a degree of binding capabilities or the conformational change to be extended. In addition, the ligands can be dissolved into a solvent other than water and development of a ligand which can be used in an organic solvent may be achieved. Examples of such modifications include, but are not limited to, sugar modifications at 2′ position, pyrimidine modifications at 5 position, purine modifications at 8 position, modifications at exocyclic amines, 4-thiouridine substitutions, 5-bromo- or 5-iodo-uracil substitutions and the like. The examples can further include a backbone modification, methylation, a rare base-pair combination (e.g., a combination of isocytidine and isoguanine that are isomerized bases) and the like. When an amplification step is carried out in the present invention, a method for amplifiable modification can be selected.

When the ligand is a peptide, the ligand includes oligopeptides which can be generated from the primary sequence of amino acids, polypeptides and chemically modified derivatives thereof. They may not necessarily be single-stranded, and may have a cyclic conformation or form a complex in which a plurality of units including a primary conformation interacts one another. Examples of the chemical modifications include, but are not limited to, various modifications (e.g., acetylation, succinylation, biotinylation, formylation, myristoylation, farnesylation, geranylation, PEGylation), fluorescent labeling, introduction of sugar chain and the like. Like the case of the nucleic acid, examples of the modifications include those providing an additional chemical group, with which modifications a whole ligand or portion thereof incorporates charge, polarizability, hydrogen bonding, electrostatic interactions and/or fluidity. Non-natural amino acid that is artificially synthesized can also be used as components of peptides of the present invention. Like the case of the nucleic acid, use of the above enables variations of the affinity for a target substance and a degree of binding capabilities or the conformational change to be extended. In addition, the ligands can be dissolved into a solvent other than water, and development of a ligand which can be used in an organic solvent may be achieved.

The term “candidate ligands precursor” herein refers to a molecule that can be used as a mixture of candidate ligands by a chemical or in vivo reaction although the precursor itself is not used as a screening candidate. Specifically, examples of the precursor include, but are not limited to, vectors having a gene encoding an amino acid sequence, nucleic acids or peptides that are protected by modification groups so as to regulate the reactivity of a part of the functional groups (e.g., an amino group, a thiol group, a carboxyl group, a hydroxyl group) of the ligand, and the like. These precursors can be recovered as a mixture of candidate ligands by utilizing an expression system in a host cell (e.g., E. coli, yeast cells, plant cells, animal cells that are commercially available for protein expression) or a cell-free protein expression system. Alternatively, they can be recovered as a mixture of candidate ligands by removing the protected groups by chemical treatment. Keeping as a precursor until right before the screening can result in effects such as the effect of keeping variations of the candidate ligand molecules and the effect of allowing the highly reproducible screening to be performed.

The term “first mixture of candidate ligands” herein refers to a mixture of candidate ligands before the screening which can be obtained as above. In addition, a mixture of candidate ligands, enriched for the desired ligand to be obtained by a method for screening of the present invention, can be used as a new first mixture of candidate ligands. A second mixture of candidate ligands refers to a mixture of candidate ligands that is separated and collected from the first mixture of candidate ligands. Specifically, the second mixture of candidate ligands is a mixture of free candidate ligands not bound to the carrier obtained by contacting ligands with the carrier under the absence of a target substance, and removing a mixture of candidate ligands bound to the carrier (a mixture of candidate ligands enriched for a ligand not having a particular conformation under the absence of the target ligand). Alternatively, the second mixture of candidate ligands is a mixture of candidate ligands obtained by contacting ligands with the carrier under the presence of a target substance, and collecting a mixture of candidate ligands bound to the carrier (a mixture of candidate ligands enriched for the ligand, at least a part of which has a particular conformation by binding to the target).

(Carrier)

The carrier herein does not have any limitations regarding its material and shape, as long as being able to have a recognizing site recognizing at least a part of a particular conformation. As a material of the carrier, materials used for DNA microarrays, nucleic acid purification and ELISA (Enzyme-Linked ImmunoSorbent Assay) can be employed. Examples of them include, for example, plastics, inorganic polymers, metals, metal oxides, natural polymers, composite materials thereof and the like.

Specific examples of the plastics include polyethylene, polystyrene, polycarbonate, polypropylene, polyamide, phenol resin, epoxy resin, polycarbodiimide resin, polyimide, acrylic resins and the like. Specific examples of the inorganic polymers include glass, quartz, carbon, silica gel, graphite and the like. Specific examples of the metals and metal oxides include gold, platinum, silver, copper, iron, aluminum, magnet, ferrite, alumina, silica, paramagnet, apatite, oxides thereof and the like. Examples of the natural polymers include poly amino acid, cellulose, chitin, chitosan, alginate, agarose and derivatives thereof.

In order to have a recognizing site recognizing at least a part of a particular conformation on a carrier, a functional group can be introduced on the surface of the material of the carrier. Apart from the introduction of the functional group, the functional group may be physically adsorbed directly onto the surface. A conventional known immobilization method can also be used for the surface of various carriers in the present invention.

There is a possibility that a random immobilization (e.g., physical adsorption such as electrostatic adsorption utilizing hydrophobicity and charge of a ligand) cannot retain an amount of immobilization due to a lower binding affinity for the carrier per molecule. Accordingly, for the immobilization of a low-molecular-weight molecule, chemical bonds may be used. In particular, a terminal of the molecule may be immobilized thereon.

For example, for the case of direct immobilization onto gold, a molecule whose terminal is thiolated can be used. When carboxylic acid groups are introduced on the surface of the carrier, the dehydration-condensation of the molecule whose terminal is aminated enable the immobilization to be carried out. Further, when streptavidin or avidin is introduced on the surface of the carrier, a molecule whose terminal is biotinylated can be used.

In order to facilitate a reaction of the mixture of candidate ligands with a recognizing site which is created on the carrier and recognizes at least a part of particular conformation, a linker can be inserted between the recognizing site on the carrier and the ligands. Insertion of the linker allows the steric hindrance of the molecule to be reduced during a solid-phase reaction of the carrier. The length and kind of the linker can be appropriately selected depending on the reaction efficiency.

So as to further facilitate the reaction, the carrier can be processed into microparticles. The microparticulation enables the surface area to be enlarged, which should have a promoting effect due to a lower reaction volume, reaction under a high concentration condition and a pseudo-liquid-phase reaction while stirring. The microparticles can be also used so as to simplify the separation step. Examples of the use include centrifugation of the microparticles, purification with the microbeads-packed column, separation and recovery using the magnet and the like. A technique to separate a free ligand from a ligand binding to a carrier can employ a conventional known technique. In addition, a technique to purify a carrier binding to a ligand from a free target substance can also employ a conventional known technique in a similar manner.

(Recognizing Site)

The “recognizing site” herein refers to a site created on the carrier so as to recognize at least a part of a particular conformation that a ligand forms. The carrier itself may form a recognizing site, and alternatively a substance having the recognizing site may be supported on the whole surface of the carrier or the portion thereof. The recognition possessed by the “recognizing site” not only includes recognition that a conformation formed by a ligand is recognized by a complementary conformation thereof, which is exemplified as a relationship between “lock” and “key”, but also includes recognition resulting from a molecular-level interaction (e.g., hydrogen bonding, electrostatic interactions, dipole-dipole interactions, hydrophobic interactions) between the ligand and the recognizing site.

Examples of the substance that forms a recognizing site according to the present invention include biological molecules (e.g., nucleotides, oligonucleotides, polynucleotides, amino acids, oligopeptides, polypeptides, monosaccharides, disaccharides, oligosaccharides, polysaccharides, proteins, glycoproteins, enzymes, antibodies, membrane proteins, transcription factors, lipids, carbohydrates, metabolites, ribosomes, transition-state analogs, cofactors, inhibitors, drugs, nutrients, hormones).

When a nucleic acid is screened as a ligand, a recognizing site, which hybridizes one nucleic acid with another nucleic acid by utilizing the formation of Watson-Click's base pair with a candidate nucleic acid ligand to be screened under the presence or the absence of a target substance, is excluded from the present invention.

In addition, a biological molecule that is known to recognize a particular conformation can be used. Examples of the biological molecule include, but are not limited to, Zn finger proteins or porphyrin compounds which have an affinity for the guanine-quadruplex (G-quadruplex) conformation that is a conformation known to be formed by the telomeric domain of chromosomes, Cre recombinase and agents having a steroid backbone which are known to have an affinity for the 3-way junction that is a representative conformation formed by nucleic acids, histone H1 or human mitochondrial transcription factor A which is a protein known to have an affinity for the 4-way junction, antibodies or fragments thereof which recognize a conformation formed by various nucleic acids or peptides, enzymes and the like.

In a case when information of a publicly known biological molecule that can recognize a desired conformation is not available, a desired biological molecule that recognize the conformation can be obtained using a molecule having information of the desired conformation or a similar conformation. A biological molecule having a targeted recognizing site can be obtained using a publicly known screening technique or a screening using publicly known DNA or RNA libraries, peptide libraries or antibody (fragment) libraries. Commercially available libraries can be used for these libraries. In addition, any libraries can also be constructed by using a chemical synthesis technique utilizing a procedure of combinatorial chemistry or a publicly known genetic engineering technique. In addition, in order to verify whether or not the resulting biological molecule recognizes the desired conformation, interaction-analyzing devices (e.g., a surface plasmon resonance (SPR) sensor, isothermal titration calorimetry (ITC), a quartz crystal microbalance (QCM) sensor) can be used for analysis. Besides, by conducting NMR analysis or X-ray crystallography, it can be investigated whether or not the desired conformation is recognized or formed.

In addition, the recognizing site may be formed by a polymer having a space and/or surface shape capable of recognizing at least a part of the particular conformation. A polymer that is formed with a molecular imprint technique can be utilized as such a polymer. The molecular imprint technique refers to a technique for synthesizing a molecular imprinted polymer (MIP) that is a functional polymer capable of binding to a template molecule. In the technique, the conformation and physicochemical property of the template molecule are recognized using a molecule of the binding subject as a template.

The MIP can be produced as follows, but the method for production is not limited to the followings. The MIP made of organic polymers can be produced by allowing the coexistence of the template molecule, a functional monomer (which interacts with the template molecule by using hydrogen bonding, an electrostatic interaction and a hydrophobic or hydrophilic interaction) and a cross-linking monomer, followed by polymerizing and thereafter removing the template molecule. Alternatively, after a complex of the template molecule and the functional monomer is formed by covalent bonds, the cross-linking monomer is mixed to polymerize them. Then, the MIP can be produced by removing the template molecule from the resulting polymer by hydrolysis, etc.

In addition, the MIP made of inorganic polymers can be obtained by allowing the coexistence of the template molecule during a sol-gel reaction. Examples of the functional monomer as an organic molecule include, but are not particularly limited to, methacrylic acid, acrylic acid, methyl acrylate, ethyl acrylate, vinyl acetate, acrylamide, styrene, N,N′-methylene-bisacrylamide, acrylate, methacrylic acid amide, methyl methacrylate, ethyl methacrylate, N-succinimidyl, methacrylate, methacrylonitrile and the like.

In addition, examples of the functional monomer as an inorganic molecule include, but are not limited to, metal alkoxides (e.g., titanium butoxide, zirconium propoxide, aluminium butoxide, niobium), other metal alkoxides (e.g., methyltrimethoxysilane, diethyldiethoxysilane), metal oxides (e.g., titanium oxide, aluminum oxide) and the like.

Alternatively, the molecular imprinted polymer can be produced by a method (phase-inversion process) including dissolving the template molecule into a dissolved or melted polymer to solidify with functional groups of the polymer via covalent or non-covalent bonds, followed by removing the template molecule.

In the present invention, a molecule whose desired conformation or conformation similar thereto is publicly known can be utilized as a template molecule. Whether or not the MIP produced has a given feature can be verified with a fine structure analysis (e.g., atomic force microscopy (AFM), electron microscopy, X-ray photoelectron spectroscopy (XPS)) under the presence or the absence of the template molecule. Alternatively, the binding affinity of the MIP for the template molecule can be verified with SPR and QCM, etc.

Alternatively, a molecule (e.g., a clathrate), as a polymer, which provides a space having higher order and capable of recognizing a particular molecule can be used to construct a recognizing site. Examples of such a clathrate that can be used include, but are not limited to, compounds (e.g., crown ether, cyclodextrin, calixarene, hydroquinone, deoxycholic acid, amylose, fullerene, porphyrin, zeolite).

As a method for screening of the present invention, a plurality of different carriers, each of them having a different recognizing site, may be used, or a single carrier having a plurality of different recognizing sites may also be used.

(Reaction Condition)

Conditions for the step of a method for screening of the present application are desirable to be set to conditions identical to conditions for actual use of a ligand (e.g., solution conditions such as a temperature, pH, a salt concentration, an additive). In particular, it is included that individual steps and a step of contacting a free target substance may be carried out under the same condition (e.g., solution conditions such as a temperature, pH, a salt concentration). In respect to the addition of nonspecific adsorption inhibitors to a carrier, conditions may differ from those of the actual use.

(Target Substance)

The target substance herein means a compound or molecule that is desired and is a subject of interest. The target substance can be a wide variety of molecules (e.g., biopolymers represented by proteins, low-molecular-weight compounds such as metabolites). Specific examples of the target substance can include, but are not particularly limited to, proteins, peptides, carbohydrates, sugars, glycoproteins, hormones, antibodies, metabolites, transition state analogs, cofactors, inhibitors, drugs, nutrients and the like. That is, as long as being able to form an interaction with a ligand, the target substance does not have a particular limitation, and can be appropriately selected depending on its purpose.

(Combination with a Technique for Screening for a Ligand Based on the Affinity for a Target Substance as an Index)

A ligand having a more affinity for a target substance can be obtained from a mixture of candidate ligands by using a method including the following steps (i) to (iii) before step (a), and/or step (b) or step (b′) of a method of for screening the present invention. Step (i) is a step of contacting a target substance with the first or second mixture of candidate ligands. Here, a candidate ligand molecule that has an increased affinity for the target substance compared to the mixture of candidate ligands can be fractionated from the remaining mixture of candidate ligands. Step (ii) is a step of separating and collecting a candidate ligand binding to the target substance. Step (iii) is a step of producing a new first or second mixture of candidate ligands by amplifying the candidate ligand separated and collected.

In addition, a ligand having a more affinity for a target substance can be obtained from a mixture of candidate ligands by using a method including the following steps (i′) to (iii′) after step (d) or step (d′) of a method for screening of the present invention. Step (i′) is a step of contacting a target substance with the mixture of candidate ligands. Step (ii′) is a step of separating and collecting a candidate ligand binding to the target substance. Step (iii′) is a step of producing a new mixture of candidate ligands by amplifying the candidate ligand separated and collected.

The above step is a general step of screening for a ligand based on the affinity for a target substance as an index. When a ligand includes a nucleic acid, the method can be a SELEX method. When a ligand includes a peptide, the method can use selection methods including a phage display method, an mRNA display method, a ribosomal display method, a cell-surface display method and the like. These methods and improved methods thereof which are known to those skilled in the art can be combined with a method of the present application.

There is no particular limitation regarding a manner of the combination and an order of the steps in the combination. In an embodiment, a mixture of candidate ligands having an affinity increased by the above method for selecting a ligand having an affinity for a target substance may be obtained. Next, an untargeted candidate ligand of the present application forming at least a part of a particular conformation as an initial conformation is separated and removed under the absence of a free target substance. Then, a targeted ligand of the present application forming at least the part of the particular conformation under the presence of the free target substance is separated and collected.

A desirable screening method has the fewer number of steps as possible from the viewpoints of reduction of loss during collection or bias reduction in properties of the targeted ligand to be obtained. The above step of separation utilizing a difference in a binding affinity for a recognizing site can be performed the same number of times as the step of selecting a ligand having the affinity for the target substance (e.g., a screening utilizing a SELEX method or a variety of display techniques), but the number is not particularly limited. For example, performing selections for a mixture of candidate ligands for more than two rounds, and then, for the candidate ligands obtained in the final round, a targeted ligand can be obtained by carrying out a separation utilizing a difference in a binding affinity for a recognizing site on a carrier for one time. In addition, the number of times of the step of separation utilizing a difference in a binding affinity for each recognizing site can be determined depending on its purpose,

The individual number of times of the step of separation may differ. The reaction conditions (e.g., a temperature, pH, a salt concentration, a solvent) is desirable to be identical between the step of screening based on the affinity as an selective pressure and the step of separation utilizing a difference in a binding affinity for a recognizing site on a carrier. Additives (e.g., inhibitors of non-specific adsorption of a target substance or a mixture of candidate ligands to a carrier) can be appropriately changed because they depend on the types of carriers and the functional groups on the surface thereof, the types of a target substance and the like. The above principle of obtaining a ligand by utilizing an affinity for a target substance as an selective pressure can also be used in the present invention, and is not particularly limited.

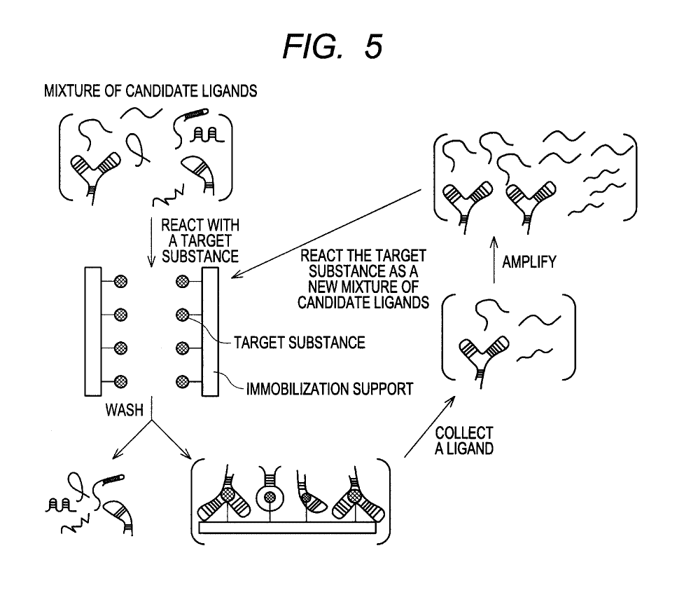

FIG. 5 illustrates a general example of the above method for screening based on the binding affinity. The screening process involve the immobilization of a target substance on a solid support, reaction of the target substance with a mixture of candidate ligands so as to form a complex of the target substance with a ligand having a higher affinity for the target substance, t, and collection of the ligand forming a complex with the target substance after washing the reaction. By changing stringency during the reaction and washing in this process, a ligand having a more affinity can be obtained. Examples of the stringency include a temperature, pH of a buffer, a salt concentration, an additive, the number of washing steps during the reaction or washing and the like, and can be modified depending on its purpose.

In addition, the above solid support is defined as any surfaces that enable a target substance to be linked via a covalent bond or non-covalent bond. Examples of the solid support include, but are not limited to, membranes, plastics, paramagnetic beads, charged papers, nylon, Langmuir-Blodgett films, functionalized glass, germanium, silicon, PTFE, polystyrene, gallium arsenide, gold and silver. Also intended are any additional materials known to those skilled in the art, the materials including those having functional groups (e.g., an amino group, a carboxyl group, a thiol group, a hydroxyl group) disposed on the surface. These surfaces include any topological surfaces, including, but are not limited to, a spherical surface, a grooved surface and a cylindrical surface. In contrast, it is also possible to make a complex form by contacting a free target substance without using a solid support, followed by fractionation from the remaining mixture of candidate ligands by utilizing the physical property due to the complex. For example, isothermal electrophoresis and chromatography techniques can be available.

A conventional known method can be employed as a step of amplification of the present invention. When a ligand is a nucleic acid, a PCR method, for example, can be used. When a single-stranded nucleic acid is needed, for example, first, a mixture of candidate ligands is amplified by a PCR method using a biotinylated primer, and then, from the duplex after the amplification by the PCR method, an a complementary strand of the untargeted nucleic acid ligand sequence can be separated and removed with a streptavidin column. A step of amplification and the following step of purification are not limited to the above described method.

When the step of amplification is carried out, the sequence of a mixture of candidate nucleic acid can include a variety of sequence domains (e.g., a random sequence domain, a conserved sequence domain), as well as can further include a primer sequence domain, which contains a fixed sequence, for amplification. A primer sequence domain for PCR amplification can be inserted at both the ends of a mixture of candidate nucleic acid. The primer sequence domain is not particularly limited. However, when the mixture of candidate nucleic acid ligand contains a conserved sequence domain, a sequence that is not likely to form a secondary conformation with the foregoing conserved sequence domain may be selected. This allows the efficiency of the PCR amplification to become higher.

Software for predicting a secondary structure of a nucleic acid (e.g., mfold software) can be used as a determination method. The ligand can be selected by employing a portion of various sequence domains as some model sequences, setting a conserved sequence domain and a primer sequence domain for amplification, and examining the possibility for formation of the secondary structure between the conserved sequence domain and the primer sequence domain for amplification. Besides, the whole region of the conserved sequence domain or the portion thereof can be utilized as a portion of the primer sequence domain for amplification. The primer sequence domain may be removed after the step of amplification so as to attenuate the contribution to the nucleic acid ligand conformation of the primer sequence domain for amplification. Insertion of the recognition site of restriction enzyme into the primer sequence enables a site-specific removal to be implemented. In addition, a nucleic acid sequence may be inserted between respective sequence domains as a linker portion.

Even if a ligand is a peptide, the ligand can be amplified using a variety of methods known to those skilled in the art. For example, when a phage display method is used, first, E. coli is infected with a recovered phage. Then, a candidate ligand molecule can be amplified by collecting the phage that is amplified in the cell.

(Sensor and Additional Use)

A ligand obtained according to the present invention is considered to be, for example, a multifunctional drug or substance which performs drug delivery with high accuracy by identifying as the ligand capable of specifically interacting with metabolites or proteins involving with a particular metabolic pathway. Further, it is deemed that identification of the ligand capable of specifically interacting with a molecule which mimics a reaction intermediate enables a multistep reaction undergoing the unstable reaction intermediate to proceed efficiently. In addition, the ligand can be used as a molecular recognition element of a biosensor by adsorbing or attaching onto quartz crystal units, surface plasmon resonance substrates, electrodes or surface acoustic wave devices. In particular, examples of the use may include chemical- and bio-sensors, molecular switches, signal transduction molecules and the like, which utilize a particular conformational change upon binding to a target substance.

### EXAMPLES

Hereinafter, although Examples that the present invention is applied to are described, they do not limit the scope of the present invention.

### Example 1

Based on the method illustrated in FIG. 1, a screening for a nucleic acid ligand is carried out, the ligand undergoing a conformational change into a conformation that is one of representative conformations formed by nucleic acid. A single-chain antibody fragment (scFv) is used as a substance having a recognizing site recognizing a 3-way junction. A ligand capable of forming a desired conformation upon binding to a target substance can be screened in a manner similar to the following method even if the target substance or the desired conformation varies.

A nucleic acid whose 5′ end is modified with an amino group is prepared by chemical synthesis, the nucleic acid having the following SEQ ID NO: 1 whose NMR information on the conformation is disclosed in a databank (PDB ID: 1SNJ). The chemical synthesis is carried out with a commercially available DNA synthesizer (AKTAoligopilot plus 10/100 (manufactured by GE Healthcare Inc.)) by following a designated protocol.

SEQ ID NO: 1:
5′-CGTGCAGCGGCTTGCCGGCACTTGTGCTTCTGCACG-3′

Based on a method described in Clackson T. et al., Nature, 1991, vol. 352, 624-628, a single-chain antibody fragment (single chain Fv, scFv) library which recognizes the conformation of the nucleic acid set forth in SEQ ID NO: 1 is constructed. BALB/C mice are immunized with a solution containing DNA set forth in SEQ ID NO: 1 together with calf serum albumin and complete Freund's adjuvant every two weeks for the total of four times. Next, the spleens of the mice are extirpated, and RNA is extracted to synthesize cDNA according to the described protocol. Then, a cDNA library including VH or Vκ is constructed using, as a probe, a sequence encoding VH or Vκ, which is a variable region of a heavy chain or a light chain, respectively, of an antibody involving with the binding to an antigen. Genes encoding a VH or Vκ can be obtained by performing PCR under the described condition using the described primers for the respective VH or VL. A gene that encodes a single-chain antibody fragment is constructed as follows. First, a gene encoding a single stranded antibody fragment in which three tandem repeats of an amino acid sequence, (GGGGS), as a linker amino acid sequence is inserted into the above gene between a VH gene and a VL gene based on the sequences obtained. Next, the resulting gene is integrated into a phagemid vector. Then, E. coli, TG-1, is transformed with this phagemid vector by using electroporation. Finally, the E. coli is co-infected with a helper phage to prepare a scFv phage library.

An scFv having a binding affinity for the nucleic acid set forth in SEQ ID NO: 1 is obtained using the above scFv phage library. An aqueous solution containing the nucleic acid is incubated at 95° C. for 5 minutes, and is then placed at room temperature for 30 minutes without stirring. A solution containing carbodiimide (1-ethyl-3-(3-dimethylaminopropyl) carbodiimide hydrochloride) is mixed with the nucleic acid solution described above. Carboxyl group-modified magnetic microbeads (BiomagPlus Carboxyl (manufactured by Polysciences Inc.)) are immediately mixed therewith, and incubated at room temperature for 24 hours while stirring. After collecting the magnetic beads by using a magnetic stand, a supernatant is removed. The washing procedure that Milli-Q water is added, the magnetic beads are again collected and a supernatant is removed. This process is repeated three times. Next, to the resulting nucleic acid-immobilized magnetic beads is added the phage library, and the mixture is incubated in a buffer (50 mM Tris (hydroxymethyl)aminomethane (Tris), 300 mM sodium chloride (NaCl), 30 mM potassium chloride (KCl), 5 mM magnesium chloride (MgCl₂), pH7.6) at room temperature while stirring. Phages which do not bind to the magnetic beads or which bind nonspecifically thereto are removed by washing with the buffer amd then phages which bind to the magnetic beads are collected. E. coli is infected with the above recovered phages to construct a new phage library. This series of procedures is repeated to enrich an scFv having a significant affinity for the nucleic acid set forth in SEQ ID NO: 1. DNA is extracted from the enriched phages, and the DNA sequences are determined to obtain the genetic information of the gene encoding the scFv having a significant affinity for the nucleic acid set forth in SEQ ID NO: 1. The resulting gene is artificially synthesized and integrated into a commercially available plasmid vector, pET-22b(+) (manufactured by Novagen Inc.) for protein expression. The scFv expressed in E. coli is obtained by referring to a method described in Umetsu M. et al., J. Biol. Chem., 2003, vol. 278, 8979-8987. The buffer for the resulting scFv is replaced by phosphate buffered saline (PBS). The replacement of the buffer is carried out by dialysis.

### Example 2

The ability to recognize the conformation of the resulting scFv is determined as follows.

The following sequences are designed using nucleic acid secondary conformation prediction software, mfold, (Zuker M. Nucleic Acids Research, 2003, vol. 31, 3406-3415) to synthesize them. Nucleic acid sequences (SEQ ID NOs: 2 to 5) that are predicted not to form a 3-way junction and nucleic acid sequences (SEQ ID NOs: 6 and 7) that have a 3-way junction identical to that of SEQ ID NO: 1 in the length of nucleotides and the number of bases in the stem region and the loop are designed to synthesize them with a DNA synthesizer.

The binding affinity of the scFv obtained in Example 1 for the nucleic acid sequences set forth in SEQ ID NOs: 1 to 5 is determined with a surface plasmon resonance (SPR) measurement device. BIAcoreX (manufactured by GE Healthcare Inc.) is used as a SPR measurement device. A coat of carboxymethyldextran is applied to the gold film surface of a SPR sensor substrate (CM5, manufactured by GE Healthcare Inc.). Then, the substrate is installed in the BIAcoreX. Immobilization of the scFv onto the sensor substrate is carried out according to a designated protocol. A mixed solution containing N-hydroxysuccinimide (NHS) and N-ethyl-N′-(3-dimethylaminopropyl)carbodiimide hydrochloride (EDC) provided by an amine coupling kit (manufactured by GE Healthcare Inc.) is prepared, and the substrate is treated therewith for 7 minutes with a rate of 5 μl/min. The scFv solution obtained in Example 1 is treated at a concentration of 10 μM for 7 minutes, and further treated with an ethanolamine solution provided by the amine coupling kit (manufactured by GE Healthcare Inc.) for 7 minutes. This operation allows the scFv to be immobilized via a carboxymethyl group. The running buffer is changed to a buffer (50 mM Tris, 300 mM NaCl, 30 mM KCl, 5 mM MgCl₂, pH7.6) used in the screening. When the signal is stabilized, the nucleic acid solution (10 μM) containing SEQ ID NO: 1 is injected at a flow rate of 20 μl/min. Nucleic acid solutions containing each of SEQ ID NOs: 2 to are measured similarly. SPR signals are observed to increase in the nucleic acid solutions containing each of SEQ ID NOs: 1, 6 and 7 compared to those for SEQ ID NOs: 2 to 5. Accordingly, the scFv obtained in Example 1 can be verified to recognize the 3-way junction which are composed of SEQ ID NO: 1 and a similar conformation thereof.

### Example 3

Cholic acid is used as a target substance. A single-stranded nucleic acid ligand capable of forming a conformation including a 3-way junction upon binding to cholic acid is obtained as follows.

A single-stranded DNA library having an internal random sequence domain set forth in SEQ ID NO: 8 is synthesized with a DNA synthesizer. The single-stranded DNA library includes fixed sequence domains for PCR amplification (from 5′-end, 1st to 18th nt. and 55th to 72nd nt.) and an internal random sequence domain (19th to 54th nt.).

The scFv obtained in Example 1 is immobilized on magnetic microbeads whose surface is modified with a carboxyl group provided by BioMag Plus Carboxyl Protein Coupling Kit (manufactured by Polysciences Inc.) according to a method described in the protocol. The scFv-immobilized magnetic beads constructed and the single-stranded DNA library can be used as a kit for screening for a single-stranded DNA capable of forming a 3-way junction upon binding to a target molecule. The library constructed is dissolved into a buffer (50 mM Tris, 300 mM NaCl, 30 mM KCl, 5 mM MgCl₂, pH7.6) to a concentration of 50 nM. Next, the mixture is mixed with the scFv-immobilized magnetic microbeads, and is incubated at room temperature while stirring. A reaction supernatant after incubation is collected using a magnetic stand.

SEQ ID NO: 8:
5′-GTACCAGCTTATTCAATTNNNNNNNNNNNNNNNNNNNNNNNNNNNN
NNNNNNNNAGATAG TATGTTCATCAG- 3 ′

To the reaction supernatant collected are added magnetic beads on which cholic acid (Wako Pure Chemical Industries, Ltd.) is immobilized as a target substance by using BioMag Plus Amine Protein Coupling Kit (manufactured by Polysciences Inc.). The magnetic beads are collected using a magnetic stand and washed with a buffer. A high concentration (5 mM) of cholic acid is added to incubate with the beads while stirring so as to separate a candidate DNA from the cholic acid-immobilized magnetic beads. This operation allows DNA binding to the cholic acid on the magnetic beads to be separated. Next, a DNA solution from which cholic acid is eliminated using SV Gel and PCR clean up system (manufactured by Promega Inc.) is obtained. Then, DNA is purified. To the DNA solution is added free cholic acid having a final concentration of 10 μM, and the mixture is incubated at room temperature for 1 hour. To a solution after incubation are added newly prepared scFv-immobilized magnetic beads, and the mixture is incubated at room temperature while stirring. The DNAs which are nonspecifically adsorbed onto the magnetic beads are removed by washing with a buffer. In order to separate DNA from the magnetic beads after washing, an alkaline solution is added and a supernatant is then collected.

The solution is neutralized with hydrochloric acid, and the DNA is then purified by using SV Gel and PCR clean up system. Whether or not the DNA is recovered is verified by an absorbance determination and electrophoresis. A PCR is carried out by using LA Taq DNA polymerase (manufactured by TAKARA BIO Inc.) and by using both the DNA set forth in SEQ ID NO: 9 and the DNA whose 5′ end is labeled with biotin (SEQ ID NO: 10) as primers according to a designated protocol. Next, agarose gel electrophoresis is performed. Then, a gel containing the intended length of nucleotides (72mer) is excised by referring to positions of DNA markers. After that, the DNA is purified by using SV Gel and PCR cleanup system. By referring to a method described in Mayer G., Nucleic Acid and Peptide Aptamers, 2009, 19-32, a single-stranded DNA is collected from the double-stranded DNA after purification, by using BioMag Plus Streptavidin, streptavidin-modified magnetic microbeads (manufactured by Polysciences Inc.). The collected single-stranded DNA is purified by using SV Gel and PCR clean up system (manufactured by Promega Inc.). The above series of operations is repeated 10 times. The DNA finally obtained is inserted into a vector for cloning (pGEM T-easy (Promega Inc.)), according to the protocol. Next, E. coli is transformed with the resulting vector. Then, the plasmid is extracted from the E. coli. After that, DNA is amplified from the plasmid DNA by using SP6 primer (SEQ ID NO: 11) or T7 primer (SEQ ID NO: 12) and DTCS Quick Start kit (manufactured by Beckman Coulter Inc.), according to the protocol provided. Nucleotide sequences of a plurality of DNAs obtained in the screening are obtained using a DNA sequencer, CEQ8000 (manufactured by Beckman Coulter Inc.) according to a recommended protocol.

SEQ ID NO: 9:
5′-GTACCAGCTTATTCAATT-3′
SEQ ID NO: 10:
5′-CTGATGAACATACTATCT-3′
SEQ ID NO: 11:
5′-ATTTAGGTGACACTATAG-3′
SEQ ID NO: 12:
5′-TAATACGACTCACTATAG-3′

### Example 4

By using CM5 substrate, cholic acid is immobilized on the substrate via amine coupling in a manner similar to Example 2. Synthesized is a DNA sequence that the fixed sequences for PCR amplification at both the ends are removed from the sequence obtained in Example 3. Next, the DNA is injected onto the sensor substrate with a flow rate of 20 μl/min. Then, an increased SPR signal is observed. In contrast, when the identical concentration of a solution containing a library for the single-stranded DNA set forth in SEQ ID NO: 8 is added, such an increased signal is not obtained. Accordingly, it is verified that the DNA having a binding affinity for cholic acid is enriched by the screening of Example 2.

### Example 5

### Obtaining and Screening for a Protein which Recognizes a Conformation

A conformation of the sequence in which the fixed sequences at both the ends are removed from the nucleic acid sequence obtained in Example 3 is analyzed by mfold. It is verified that the resulting DNA does not have, as an initial stable conformation, a 3-way junction which the nucleic acid set forth in SEQ ID NO: 1 possesses. In addition, a DNA sequence in which the fixed sequences at both the ends are removed is synthesized with a DNA solid-phase synthesizer by using ¹³C— and ¹⁵N-labeled nucleotides as a monomer. The DNA is subjected to a conformational analysis by NMR under the presence and the absence of cholic acid. Among the DNAs obtained by the screening, it can be demonstrated that some of those having the 3-way junction including a conformation similar to the conformation disclosed in PDB ID: 1SNJ are obtained.

### Comparative Example 1

In a manner similar to Example 3, a DNA sequence binding to cholic acid is obtained using a library of the single-stranded DNA set forth in SEQ ID NO: 8 by a general SELEX method. Cholic acid-immobilized magnetic beads are prepared by a method similar to Example 3. A solution for the single-stranded DNA library is mixed with the cholic acid-immobilized magnetic microbeads, and the mixture is incubated at room temperature while stirring. After washing with a buffer, the DNA binding to the magnetic beads are separated by adding a solution containing 5 mM of cholic acid. In a manner similar to Example 3, DNA is amplified using LA Taq by PCR. Next, agarose gel electrophoresis is performed. Then, a gel containing the intended length of nucleotides (72mer) is excised. After that, the DNA is purified by using SV Gel and PCR cleanup system. A single-stranded DNA is collected from the double-stranded DNA after purification by using BioMag Plus Streptavidin (manufactured by Polysciences Inc.), streptavidin-modified magnetic microbeads. Finally, the DNA is purified using SV Gel and PCR clean up system (manufactured by Promega Inc.). The above series of operations is repeated 10 times. Then, the nucleotide sequence of the resulting DNA is obtained in a manner similar to Example 3.

In a manner similar to Example 4, the sequence obtained by removing the sequences at both the ends is analyzed by mfold. The secondary structures obtained include a structure stabilized as a 3-way junction of the initial structure and a structure that does not form the 3-way junction. The structure that does not form the 3-way junction is subjected to a conformational analysis of the DNA conformation under the presence of cholic acid by NMR. In contrast to Example 4, it can be demonstrated that the resulting DNA forms a conformation largely different from the conformation disclosed in PDB ID: 1SNJ under the presence of cholic acid. In view of the above, in the typical screening method solely utilizing a binding affinity as a selective pressure, the enrichment of the nucleic acid sequence capable of forming a desired conformation upon binding to a target is found to be insufficient.

### Example 6

### Sensing of a Conformational Change

Selected are two nucleotides that are speculated to have a large conformational change (a change in a spacial distance) before and after the binding to cholic acid based on the conformational information obtained in Example 5. Nucleic acid having the two nucleotides that are each modified with fluorescent FAM (excitation 495 nm, emission 520 nm) or fluorescent ROX (excitation 590 nm, emission 610 nm) is synthesized with a DNA solid-phase synthesizer. Fluorescence Resonance Energy Transfer (FRET) before and after addition of cholic acid is determined with a fluorescence spectrophotometer. It is verified that the presence of cholic acid increases a ROX-derived fluorescent intensity at 610 nm upon excitation of FAM at 495 nm.

### Example 7

### Obtaining and Screening for a MIP Which Recognizes a Conformation

In a manner similar to the step shown in FIG. 3, a nucleic acid ligand is screened which undergoes a conformational change upon binding to a target substance into a guanine-quadruplex (G-quadruplex) that is a representative conformation that nucleic acid forms. A molecular imprinted polymer (MIP) is used as a conformation-recognizing member recognizing the guanine-quadruplex. A ligand capable of forming a desired conformation upon binding to a target substance can be screened in a manner similar to the following method even if the target substance or the desired conformation varies.

Obtained is a molecular imprinted polymer recognizing a conformation of the nucleic acid set forth in SEQ ID NO: 13. The nucleic acid sequence set forth in SEQ ID NO: 13 is a human telomere sequence, which is known to form a guanine-quadruplex conformation as described in PDB ID: 143D. Acrylic acid and acrylamide are used as a monomer. Methylenebisacrylamide is used as a cross-linker. Then, 2,2′-azobis{2-methyl-N-[1,1-bis(hydroxymethyl)-2-hydroxyethyl]propionamide} is used as a polymerization initiator. These agents are dissolved into a buffer (pH 7.4) containing 50 mM HEPES ((4-(2-hydroxyethyl)-1-piperazineethanesulfonic acid) and 50 mM KCl to prepare a polymer reaction solution. A gold substrate for the SPR sensor (SIA Kit Au, manufactured by GE Healthcare Inc.) is modified with a molecule having a vinyl group. A solution containing the nucleic acid is added, and is incubated. The polymer reaction solution is then added to the substrate, and a polymerization reaction is carried out by irradiating with UV light. Washing is conducted so as to remove the unreacted nucleic acid and monomers, followed by drying to obtain a nucleic acid-recognizing MIP substrate.

SEQ ID NO: 13:
5′-AGGGTTAGGGTTAGGGTTAGGG-3′

An analysis with SPR is conducted in a manner similar to Example 2, and the ability of the resulting MIP for recognizing a conformation is examined. An increase in the SPR signal is observed for the nucleic acid sequence set forth in SEQ ID NO: 13. In contrast, an increase in the SPR signal is not obtained for the nucleic acid sequence set forth in SEQ ID NO: 14. In addition, when compared with another nucleic acid sequence (SEQ ID NO: 15) known to form a guanine-quadruplex conformation, an increase in the signal is obtained. Accordingly, it can be demonstrated that the resulting MIP recognizes a conformation specific to the guanine-quadruplex conformation including the nucleic acid sequence set forth in SEQ ID NO: 13.

SEQ ID NO 14:
5′-ATTATAGATAAGTTACCATGCC-3′
SEQ ID NO: 15:
5′-GGTTGGTGTGGTTGG-3′

### Example 8

By using the MIP substrate recognizing a guanine-quadruplex conformation obtained in Example 7, a nucleic acid is obtained which forms the guanine-quadruplex conformation upon binding to a target substance, TMPyP (5,10,15,20-tetra-(N-methyl-4-pyridyl)porphine). A library for DNA set forth in SEQ ID NO: 16 is synthesized with a DNA solid-phase synthesizer. This DNA library possesses an internal nucleic acid sequence set forth in SEQ ID NO: 9. The MIP substrate recognizing a guanine-quadruplex conformation and the single-stranded DNA library can be used as a kit for screening for a single-stranded DNA capable of forming a guanine-quadruplex conformation upon binding to a target molecule. The MIP substrate of Example is immersed in 50 mM HEPES/50 mM KCl buffer solution containing the resulting DNA library. The mixture is incubated at room temperature while stirring. Next, a supernatant is collected. Then, the supernatant collected is mixed with TMPyP to have a concentration of 5 μM, and the mixture is incubated at room temperature while stirring. A newly prepared MIP substrate is immersed in the reaction solution after incubation, and the mixture is incubated at room temperature while stirring. After washing with 50 mM HEPES/50 mM KCl buffer, the mixture is placed without stirring at 65° C. for 10 minutes. The reaction mixture is collected, and a PCR is conducted in a manner similar to Example 3. After that, a single-stranded DNA is recovered. Finally, the DNA is purified by SV Gel and PCR clean up system. The above operations are defined as one cycle, and 10 cycles of the operations are carried out to yield the nucleotide sequences of the DNAs in a manner similar to Example 3.

SEQ ID NO: 16:
5′-GTACCAGCTTATTCAATTNNNNNNNNNNNNNNNAGGGTTAGGGTTA
GGGTTAGGGNNNNNNNNNNNNNNNNNNNNNNNNNAGATAGTATGTTCAT
CAG-3′

### Example 9

Measured is a CD spectrum of a DNA sequence that the sequences for PCR amplification at both the ends are removed from the DNA sequence obtained in Example 8. For the measurement of peaks observed at 240 nm and 290 nm, the signals derived from a guanine-quadruplex conformation are not observed. Hence, it is demonstrated that the guanine-quadruplex conformation is not formed as an initial conformation.

### Example 10

Synthesized is a DNA sequence that the sequences for PCR amplification at both the ends are removed from the DNA sequence obtained in Example 9. The 5′ end is modified with an amino group. The DNA is immobilized on the CM5 substrate via amine coupling in a manner similar to Example 2. When TMPyP solution, which is a target substance, is injected onto the sensor substrate, an increase in the SPR signal is observed. In contrast, when cholic acid, which is a non-target substance, is added, there appeared no SPR signal. Hence, it is demonstrated that the DNA having a binding affinity for TMPyP is enriched by the screening according to Example 8.

### Example 11

A DNA having ¹³C— and ¹⁵N-labeled nucleotides as a monomer is synthesized by removing the sequences for PCR amplification at both the ends from the DNA sequence obtained in Example 8. In a manner similar to Example 4, a conformation under the presence and the absence of TMPyP is analyzed by NMR. It can be demonstrated that a part of the DNA sequence obtained in Example 7 forms a guanine-quadruplex conformation under the presence of TMPyP.

### Example 12

Selected are two nucleotides that are speculated to have a large conformational change (a change in a spacial distance) before and after the binding to TMPyP on the basis of the conformational information obtained in Example 11. Nucleic acid having the two nucleotides that are each modified with fluorescent FAM (excitation 495 nm, emission 520 nm) or fluorescent ROX (excitation 590 nm, emission 610 nm) is synthesized with a DNA solid-phase synthesizer. FRET (Fluorescence Resonance Energy Transfer) before and after addition of TMPyP is determined with a fluorescence spectrophotometer. It is verified that the presence of cholic acid increases a ROX-derived fluorescent intensity at 610 nm upon excitation of FAM at 495 nm.

### Example 13

By using a method similar to Example 7, a MIP substrate is obtained which recognizes a conformation of the amino acid sequence (SEQ ID NO: 17) known to form a β-hairpin conformation in a stable state, the conformational information of which is obtained in PDB ID: 1UAO. The SPR analysis verifies that the resulting MIP recognizes the amino acid set forth in SEQ ID NO: 17. In contrast, it is not demonstrated that the amino acid set forth in SEQ ID NO: 18 including a random sequence binds to the MIP.

SEQ ID NO: 17:
-GYDPETGTWG-
SEQ ID NO: 18:
-VDDVFSQVCTHLRTLK-

### Example 14

By using a commercially available phage peptide library, Ph.D-12, (manufactured by New England Biolabs Inc.), obtained is a peptide capable of forming a conformation similar to that of SEQ ID NO: 13 upon binding to a target substance. Adenosine triphosphate (ATP) is used as a target substance. ATP is immobilized on a 96-well microplate. First, to an aminated 96-well plate (Sumilon ELISA plate) manufactured by Sumitomo Bakelite Inc. are added 1 mM of a photocrosslinking group linker, NHS-LC-Diazirine(Succinimidyl 6-(4,4′-Azipentanamido)Hexanoate) manufactured by Thermo Scientific Inc. and 200 μl/well of Phosphate Buffered Saline (PBS) buffer. Then, an amino group is reacted with the NHS at room temperature under a dark condition for 1 hour while stirring. After the reaction, the reaction solution is discarded, and 200 μl of 100 mM Tris-HCl (pH8.0) is added. Next, the mixture is treated at room temperature for 5 minutes to inactivate the unreacted NHS. Then, the solution is discarded. After washing with PBS three times, the plate is washed well with pure water. Then, 200 μl of an aqueous solution containing 1 mM ATP is added, and the plate is dried with a vacuum dryer. Thereafter, the plate is placed directly under a 365-nm UV lamp (15w×2) to carry out a crosslinking reaction for 15 minutes. After that, the plate is washed well with PBS. Finally, the plate is rinsed with water and dried under a N₂ gas to preserve it with a cover in a desiccator until its use. This method allows ATP to be immobilized without an orientation. Thus, a specific functional group is not required to be used in the immobilization.

To the ATP-immobilized substrate prepared above is added the above phage peptide library. The mixture is incubated in PBS at room temperature while stirring. Phages that do not bind to ATP or that nonspecifically bind to the substrate are washed with a buffer to be removed. The bound phages are eluted with glycine-HCl. Next, the recovered phages are neutralized with 1 M Tris-HCl buffered solution (pH 8.0). E. coli, ER2537 strain (manufactured by New England Biolabs Inc.), is infected with the recovered phage. After the culture of the E. coli, a supernatant is collected by centrifugation. Then, a solution containing 20% of PEG6000 and 2.5 M of NaCl is added to precipitate the phages. After centrifugation, the precipitate is dissolved into PBS to yield a novel phage library. The above series of operations can be carried out multiple times. Next, the MIP substrate prepared in Example 14 is immersed in a solution containing the recovered phage library. Free phages that do not bind to the substrate are collected. The collected phages are reacted with free ATP. A new MIP substrate is immersed in the reaction solution, and incubated at room temperature while stirring. A phage is eluted with Gly-HCl to collect a supernatant. E. coli, ER2537 strain (manufactured by New England Biolabs Inc.), is infected with the recovered phages, and the phages are collected as described above. The series of operations is repeated 10 times. A gene sequence encoding a peptide presented by the selected phage is analyzed with a DNA sequencer, followed by converting the gene sequence into an amino acid sequence.

### Example 15

A CD spectrum is determined using the peptide obtained in Example 14 and the peptide set forth in SEQ ID NO: 17. Since there is a big difference between both the spectra, it is demonstrated that each of them has a different conformation under the absence of a target substance (ATP).

### Example 16

The peptide obtained in Example 14 is synthesized by a solid-phase synthesis using ¹³C— and ¹⁵N-labeled amino acids as a substrate. An NMR measurement is carried out under the presence and the absence of ATP. The results regarding both the conditions can demonstrate that there is a difference between their conformations. In addition, it is verified that the peptide has a conformation, under the presence of ATP, similar to a β-hairpin conformation described in PDB ID: 1UAO.

### Example 17

Selected are two amino acid residues that are speculated to have a large conformational change (a change in a spacial distance) before and after the binding to ATP based on the conformational information obtained in Example 16. A peptide having the two amino acid residues that are each modified with fluorescent FAM (excitation 495 nm, emission 520 nm) or fluorescent ROX (excitation 590 nm, emission 610 nm) is synthesized. Fluorescence Resonance Energy Transfer (FRET) before and after addition of ATP is determined with a fluorescence spectrophotometer. It is verified that the presence of ATP increases a ROX-derived fluorescent intensity at 610 nm upon excitation of FAM at 495 nm.

### Example 18

Based on the method illustrated in FIG. 2, a screening for a nucleic acid ligand is carried out, the ligand undergoing a conformational change upon binding to a target substance into a 3-way junction. The scFv obtained in Example 1 is used as a conformation-recognizing member recognizing the 3-way junction. In addition, cholic acid is used as a target substance. A ligand capable of forming a desired conformation upon binding to a target substance can be screened in a manner similar to the following method even if the target substance or the desired conformation varies.

A single-stranded DNA library having an internal random sequence domain set forth in SEQ ID NO: 8 is constructed with a DNA synthesizer.

To a solution containing 50 nM of the DNA library solution (buffer: 50 mM Tris, 300 mM NaCl, 30 mM KCl, 5 mM MgCl₂, pH 7.6) is added cholic acid to have a final concentration of 10 μM, and the mixture is incubated at room temperature while stirring. The reaction solution after incubation is mixed with scFv-immobilized magnetic beads obtained in a manner similar to Example 3. Next, the mixture is incubated at room temperature while stirring. A supernatant after the reaction is removed. After washing with a buffer containing cholic acid, the DNA which binds to the magnetic beads is collected by adding an alkaline solution. The supernatant is neutralized, and the DNA is purified by SV Gel and PCR clean up system. To the DNA solution collected are added new scFv-immobilized magnetic beads, and the mixture is incubated at room temperature while stirring. The supernatant is collected, and also the DNA is purified by SV Gel and PCR clean up system. The DNA after purification is amplified by PCR in a manner similar to Example 3. By using streptavidin-immobilized microbeads, single-stranded DNA is prepared from the amplified double-stranded DNA. Then, the DNA is purified with SV Gel and PCR clean up system. The above operations are defined as one cycle, and 10 cycles of the operations are carried out to obtain the nucleotide sequence of the resulting DNA in a manner similar to Example 3.

### Example 19

The binding affinity of the DNA obtained in Example 18 for cholic acid is determined by a method similar to Example 4. Synthesized is a DNA that the fixed sequences at both the ends are removed from the DNA sequence obtained in Example 19. When this DNA solution is added to the cholic acid-immobilized CM5 substrate, the SPR signal is demonstrated to increase.

### Example 20

A conformation of the sequence in which the fixed sequences at both the ends are removed from the nucleic acid sequence obtained in Example 18 is analyzed with mfold. It is verified that the resulting DNA does not have, as an initial stable conformation, a 3-way junction which the nucleic acid set forth in SEQ ID NO: 1 possesses. In addition, a DNA sequence in which the fixed sequences at both the ends are removed is synthesized with a DNA solid-phase synthesizer by using ¹³C— and ¹⁵N-labeled nucleotides as a monomer. The DNA is subjected to a conformational analysis by NMR under the presence and the absence of cholic acid. Among the DNAs obtained by the screening, it can be demonstrated that some of those having the 3-way junction, under the presence of cholic acid, including a conformation similar to the conformation disclosed in PDB ID: 1SNJ are obtained.

### Example 21

Selected are two nucleotides that are speculated to have a large conformational change (a change in a spacial distance) before and after the binding to cholic acid based on the conformational information obtained in Example 20. Nucleic acid having the two nucleotides that are each modified with fluorescent FAM (excitation 495 nm, emission 520 nm) or fluorescent ROX (excitation 590 nm, emission 610 nm) is synthesized with a DNA solid-phase synthesizer. Fluorescence Resonance Energy Transfer (FRET) before and after addition of cholic acid is determined with a fluorescence spectrophotometer. It is verified that the presence of cholic acid increases a ROX-derived fluorescent intensity at 610 nm upon excitation of FAM at 495 nm.

### INDUSTRIAL APPLICABILITY

The ligands identified by the present method for screening enable a desired conformation to be formed due to an interaction with a target substance. They can be used as chemical sensors, biosensors, molecular switches, signal transduction molecules and the like, which utilize this conformational change in particular. For example, introduction of a fluorescent reporter molecule into a specific site of the ligand enables a stable signal to be obtained. In addition, the site for introducing the fluorescent reporter molecule can be further precisely designed in terms of the introduction by carrying out a conformational analysis of the complex of the target substance with the ligand obtained according to the present method. Furthermore, the method for screening of the present invention can be similarly utilized even if the target substance or the desired conformation varies. Thus, the method is a systematic method for obtaining the ligand. The method has prominent advantages in the case of handling multiple materials such as in the case of allowing a sensor to be arrayed or to detect a plurality of different kinds in a bulk system. According to the method for screening of the present invention, a ligand is obtained by using both the binding affinity for a target substance and the readiness for conformational change as an index. Therefore, a concern is resolved that the binding affinity for a target substance is lost due to reengineering so as to impart the readiness for conformational change to the ligand.

### SEQUENCE LISTING

201002262127368590_A163_{—}008278101_{—}1201004355 8_AAA_{—}0.app

While the present invention has been described with reference to exemplary embodiments, it is to be understood that the invention is not limited to the disclosed exemplary embodiments. The scope of the following claims is to be accorded the broadest interpretation so as to encompass all such modifications and equivalent conformations and functions.

This application claims the benefit of Japanese Patent Application No. 2010-043558, filed Feb. 26, 2010, which is hereby incorporated by reference herein in its entirety.

What is claimed is:

1. A method for screening for a ligand, at least a part of which forms a particular conformation upon binding to a target substance, the method comprising:
(a) contacting a first mixture of candidate ligands containing a plurality of candidate ligands with a carrier having a recognizing site recognizing at least a part of the particular conformation, followed by separating and collecting, as a second mixture of candidate ligands, a mixture of free candidate ligands not bound to the carrier;
(b) contacting the second mixture of candidate ligands with the target substance; and
(c) contacting the carrier with a solution containing the target substance and the mixture of candidate ligands obtained in (b), and then separating and enriching a ligand, at least a part of which has the particular conformation when binding to the target substance, from a mixture of candidate ligands obtained in (b) by utilizing the ability of the recognizing site on the carrier to recognize at least the part of the particular conformation.

2. The method for screening according to claim 1, further comprising (d) removing the target substance from a solution containing the enriched ligand after (c).

3. The method for screening according to claim 1, wherein one of (a) and (c), or both (a) and (c) each repeat any number of times that are required.

4. The method for screening according to claim 1, further comprising: before (a) and/or (b),
contacting the first or second mixture of candidate ligands with the target substance;
separating and collecting a candidate ligand bound to the target substance; and
amplifying the separated and collected candidate ligand to produce a new first or second mixture of candidate ligands.

5. The method for screening according to claim 2, further comprising: after (d),
contacting the mixture of candidate ligands with the target substance;
separating and collecting a candidate ligand bound to the target substance; and
amplifying the separated and collected candidate ligand to produce a new mixture of candidate ligands.

6. A method for screening for a ligand, at least a part of which forms a particular conformation upon binding to a target substance, the method comprising:
(a′) contacting a first mixture of candidate ligands containing a plurality of candidate ligands with the target substance;
(b′) contacting a solution containing the target substance and the first mixture of candidate ligands obtained in (a′) with a carrier having a recognizing site recognizing at least a part of the particular conformation, followed by collecting, as a second mixture of candidate ligands, a mixture of candidate ligands bound to the carrier by utilizing the ability of the recognizing site on the carrier to recognize at least the part of the particular conformation;
(c′) removing the target substance from a solution containing the second mixture of candidate ligands; and
(d′) contacting the carrier with the mixture of candidate ligands obtained in (c′), and then separating and removing a candidate ligand, at least a part of which forms the particular conformation under the absence of the target substance, from a mixture of candidate ligands obtained in (c′) by allowing the candidate ligand to be recognized by the recognizing site, and by utilizing the ability of the recognizing site on the carrier to recognize at least the part of the particular conformation.

7. The method for screening according to claim 1, wherein the ligand comprises a nucleic acid, a peptide and a derivative thereof.

8. The method for screening according to claim 1, wherein the recognizing site disposed on the carrier comprises a biological molecule recognizing at least the part of the particular conformation.

9. The method for screening according to claim 1, wherein the recognizing site disposed on the carrier comprises a polymer having a space and/or a surface shape capable of recognizing at least the part of the particular conformation.

10. The method for screening according to claim 9, wherein the polymer is obtained by removing a template molecule from a polymer yielded by polymerizing a polymerizable monomer having a binding site capable of binding reversibly to the template molecule under the presence of the template molecule having at least the part of the particular conformation.

11. A method for identifying a ligand, at least a part of which forms a particular conformation upon binding to a target substance, the ligand obtained by a method according to claim 1.


SEQUENCE LISTING (18 sequences)

SEQ ID NO: 1 - DNA, 36 bp, Artificial Sequence
  DNA ligand
cgtgcagcggcttgccggcacttgtgcttctgcacg

SEQ ID NO: 2 - DNA, 36 bp, Artificial Sequence
  DNA Ligand
aaaaaaaaaaaaaaaaaagggggggggggggggggg

SEQ ID NO: 3 - DNA, 36 bp, Artificial Sequence
  DNA Ligand
atatatatataatatatatataatatatatataata

SEQ ID NO: 4 - DNA, 36 bp, Artificial Sequence
  DNA Ligand
acgatgtagcatgactggataatcagatcatgcatg

SEQ ID NO: 5 - DNA, 63 bp, Artificial Sequence
  DNA Ligand
cacaactagccaccaaatggtggcgcgtattaaataatacatcctcctaaagaggtagttgtg

SEQ ID NO: 6 - DNA, 36 bp, Artificial Sequence
  DNA Ligand
cgtgcagcggcttgccgggacttgtccttctgcacg

SEQ ID NO: 7 - DNA, 36 bp, Artificial Sequence
  DNA Ligand
cgtgcgacggcttgccggcacttgtgctttcgcacg

SEQ ID NO: 8 - DNA, 72 bp, Artificial Sequence
  DNA Ligand
gtaccagcttattcaattnnnnnnnnnnnnnnnnnnnnnnnnnnnnnnnnnnnnagatagtatgttcatcag

SEQ ID NO: 9 - DNA, 18 bp, Artificial Sequence
  Primer
gtaccagcttattcaatt

SEQ ID NO: 10 - DNA, 18 bp, Artificial Sequence
  Primer
ctgatgaacatactatct

SEQ ID NO: 11 - DNA, 18 bp, Artificial Sequence
  SP6 Primer
atttaggtgacactatag

SEQ ID NO: 12 - DNA, 18 bp, Artificial Sequence
  T7 Primer
taatacgactcactatag

SEQ ID NO: 13 - DNA, 22 bp, Artificial Sequence
  DNA Ligand
agggttagggttagggttaggg

SEQ ID NO: 14 - DNA, 22 bp, Artificial Sequence
  DNA Ligand
attatagataagttaccatgcc

SEQ ID NO: 15 - DNA, 15 bp, Artificial Sequence
  DNA Ligand
ggttggtgtggttgg

SEQ ID NO: 16 - DNA, 98 bp, Artificial Sequence
  DNA Ligand
gtaccagcttattcaattnnnnnnnnnnnnnnnagggttagggttagggttagggnnnnnnnnnnnnnnnnnnnnnnnnnagatagtatgttcatcag

SEQ ID NO: 17 - protein, 10 aa, Artificial
  Amino Acid Ligand
GYDPETGTWG

SEQ ID NO: 18 - protein, 16 aa, Artificial Sequence
  Amino Acid Ligand
VDDVFSQVCTHLRTLK